(19) United States
(12) Patent Application Publication
(10) Pub. No.: US 2005/0007105 A1
(43) Pub. Date: Jan. 13, 2005

(54) Device for detecting the rotational speed and/or the position of a rotating component

(76) Inventors: Henrik Siegle, Leonberg (DE); Maik Rabe, Wannweil (DE); Ulrich May, Stuttgart (DE)

Correspondence Address: KENYON & KENYON, ONE BROADWAY, NEW YORK, NY, 10004, US

(21) Appl. No.: 10/879,658

(22) Filed: Jun. 29, 2004

(30) Foreign Application Priority Data
Jul. 11, 2003 (DE) 10331580.2

(51) Int. Cl. G01B 7/30

(52) U.S. Cl. 324/207.25

(57) ABSTRACT

A device for detecting the rotational speed and/or the position of a rotating component, having at least one magnetic sensor element, which is securely connected to the rotating component, and a magnetic field sensor, which coacts with the sensor element and is designed to detect change in a magnetic field and is connected to an analyzing circuit. The magnetic field sensor includes at least one sensor element made of a sensor material exhibiting a CMR (colossal magneto resistance) effect.

### BACKGROUND INFORMATION

A device is described in German Patent Application No. DE 196 47 420, for example, and is used to detect the rotational speed of a rotating component of a motor vehicle combustion engine.

The known device is designed as a magnetoresistive device and represents a GMR (giant magneto resistance) sensor, which has a layer sequence made of ferromagnetic and non-magnetic thin layers, which coacts with a pulse-generating wheel designed as a magnetic pole wheel. The sensor is constructed in accordance with the principle of a Wheatstone bridge circuit, the four individual resistors of the bridge circuit each being formed by one GMR sensor element. The pulse-generating wheel and the sensor are positioned in relation to one another in such a way that the two bridge halves of the bridge circuit are situated in different magnetic fields, so that a differential mode voltage is applied at the bridge output. When the pulse-generating wheel is turned, the magnetic fields assigned to the two bridge halves change, thereby also changing the differential mode voltage at the bridge output.

In a GMR sensor, the problem is that the application of the thin-layer layer sequence requires expensive equipment.

At present, magnetic field sensors are used in many different ways in the field of automotive engineering and industrial automation in the recording of the rotational speed and the position of a rotating component. For example, magnetic field sensors are used to detect the wheel speed in ABS systems and systems for controlling vehicle dynamics and the rotational speed of rotating components in transmissions, as well as to determine the rotational speed and/or the position of a crank shaft or a camshaft in an internal combustion engine. In these applications, the change or even the distortion of the magnetic field that acts on the sensor via a sensor magnet is normally detected and analyzed. The sensor magnet is, for example, a movable ferromagnetic component, such as a toothed wheel, or even a defined magnetic scale, such as a multi-pole wheel, that moves past the sensor.

Current magnetic converter elements normally function according to the principle of magnetic induction, the Hall effect, or via magnetoresistive active mechanisms, in which a sensor field that changes during the rotation of the component causes a change in the electric resistance of the sensor element. In such types of converter elements, a distinction is made between field plates, in which the magnetic resistance of a semiconductor is changed by the operative Lorentz force, or AMR (anisotropic magneto resistance) sensors, and the above-mentioned GMR sensors. Furthermore, converter elements that function according to the. TMR principle (tunneling magneto resistance) effect are used. This principle is used in reading heads for storage media, in particular.

It is desirable for magnetic field sensors to be cost-effective and manufacturable using simple design and connecting technology and to exhibit simple analyzing electronics and high temperature stability of up to 200° C. of ambient temperature. Furthermore, it is desirable for interference fields to have as little effect as possible and under no circumstances an irreversible effect on the measuring signals. High sensitivity and a great signal level swing or a great signal-to-noise ratio are also key characteristics of future sensor technologies, large magnetic air gaps and high accuracy being targeted, among other things. To date, GMR technology offers the best properties in this regard.

However, the GMR effect, like the TMR effect, is an extrinsic boundary surface effect for which a sensor element having a costly layer technology is necessary, since the sensor element is formed by several ultra-thin layers, only a few nanometers thick, that may partially be made of an alloy of noble metals, such as platinum.

The GMR effect occurs in multilayer systems, which in the simplest case are made of two magnetic layers of cobalt, for example, separated by a non-magnetic interlayer of copper, for example. If the two cobalt layers couple ferromagnetically via the copper layer, the electric resistance of the layer system is small, since the electrons may enter the second cobalt layer without changing their spin. However, in the case of antiferromagnetic coupling of the two cobalt layers, the electric resistance of the layer system is great. Applying an outer magnetic field may lessen the electric resistance, since the magnetic field forces the spins of the electrons into a parallel, ferromagnetic direction. Depending on the layer stack and choice of layer thickness, typical effect variables are between 4 percent and more than 30 percent.

The TMR effect also occurs in a multilayer system, in which a non-conductive interlayer made of aluminum oxide, for example, is inserted between two magnetic layers. If a sufficiently thin non-conductive interlayer is chosen, the electrons of the magnetic layers tunnel through them, the tunneling probability being spin-dependent.

Furthermore, the CMR (colossal magneto resistance) effect is known as the intrinsic effect. In a material system showing this effect, a sizable change in resistance stemming from the suppression of a metal-insulator transition at Curie temperature TC is triggered by an applied magnetic field. The Curie temperature is the temperature below which spontaneous parallel alignment of the electron spins takes place in ferromagnetic materials so that ferromagnetism is present. In antiferromagnetic materials having corresponding anti-parallel alignment, this critical temperature is the Neel temperature TN. Materials that show the CMR effect are insulators or semiconductors above the Curie temperature and ferromagnetic metals below the Curie temperature. The CMR effect was first demonstrated in mixed-valent manganese oxides, such as LaSrMnO₃. The current flow in the oxide is supported by the jumping, i.e., hopping, of electrons between the Mn³⁺ and Mn⁴⁺ positions. However, hopping takes place only if the magnetic moments of the corresponding atoms are aligned in parallel, i.e., ferromagnetically. As a result of an outer magnetic field, this state may also be reached below the Curie temperature, thereby lowering the electric resistance of the material.

The problem of technical utilization of materials exhibiting the CMR effect previously lay in excessively low Curie temperatures that were below or close to room temperature.

Moreover, the high effect variables were achieved only with very high outer fields. The sensitivity was therefore correspondingly low.

Furthermore, compounds that show the CMR effect additionally show the PMR (powder magneto resistance) effect in polycrystalline samples. Significantly below the Curie temperature, the compounds exhibit high polarization of the electrons on Fermi energy. This results in high magneto resistances in samples having grain boundaries. The completely spin-polarized electrons may tunnel only partially into states of adjacent grains having electrons aligned differently. It is assumed that an insulating oxide layer forms the tunnel barrier here. An applied magnetic field aligns all spins within the polycrystalline sample and lowers the electric resistance of the sample.

### SUMMARY OF THE INVENTION

The device according to the present invention for detecting the rotational speed and/or the position of a rotating component, in which the magnetic field sensor has at least one sensor element made of a sensor material showing a CMR (colossal magneto resistance) effect, has the advantage that the sensor material may be manufactured in a simple manner without designing a multilayer system, i.e., for example, as a single layer made of polycrystalline or granular material, which in comparison to a magnetic field sensor having a sensor element showing a GMR effect results in lower costs. This is explained by the fact that the CMR effect is an intrinsic effect.

The measuring system of the device according to the present invention is based on the fact that a change in the magnetic field acting on the magnetic field sensor via the sensor element results in a change in the electric resistance of the sensor element. The rotational speed of the rotating component may be inferred from a periodic change in the electric resistance of the sensor element, for instance. Otherwise, the position of the rotating component may be inferred from a magnetic field characteristic for a particular angle position of the rotating component and the electric resistance of the sensor element accompanying it.

The CMR effect is based only on a change in the amplitude of the applied magnetic field, but not on a change in the direction of the magnetic field.

If the sensor material showing the CMR effect is deposited in polycrystalline form on the carrier material, it also shows the PMR effect.

The device according to the present invention is in particular suitable for determining the rotational speed of a crankshaft of a motor vehicle internal combustion engine or for determining the rotational speed of a wheel of a motor vehicle, which is often required for stabilization or brake support programs.

In a preferred embodiment of the device according to the present invention, the sensor material also has an intermetallic compound of Heusler phases, a single compound or even a composite being able to be used here.

CO₂Cr_{0.6}Fe_{0.4}Al, CO₂Cr_{0.2}Fe_{0.4}Ga, and/or CO₂Cr_{0.2}Mn_{0.8}Al may be used as particularly favorable intermetallic compounds, exhibiting a CMR effect in a temperature range prevailing in motor vehicles capable of reaching 200° C. These compounds, in particular, may also be used at temperatures significantly higher than the room temperature. At room temperature, CO₂Cr_{0.6}Fe_{0.4}Al shows magneto resistance effects of about 30% at fields of up to 100 mT, for example. A composite made of CO₂Cr_{0.6}Fe_{0.4}Al and added aluminum oxide as an insulating material yields magneto resistance changes of about 700% at room temperature at sensitivities of around 2.5%/mT. Because of the high Curie temperature of this material, which is above 300° C., this composite is particularly suitable for a magnetic field sensor used in a motor vehicle.

To be able to determine a change in the electric resistance of the sensor element in a simple manner, the sensor element may be a component of a Wheatstone bridge circuit. The sensor element is then assigned to one of four half-branches of a bridge circuit.

It is fundamentally conceivable to assign one sensor element made from a sensor material showing the CMR effect to only one of the four half-branches of the Wheatstone bridge circuit. However, with respect to the measuring signal, it has proven advantageous to manufacture at least two, preferably all four half-branches of the Wheatstone bridge circuit from one sensor material showing the CMR effect.

The individual resistors of the Wheatstone bridge circuit may be monolithically connected to an analyzing circuit in a lateral or a vertical manner.

To adjust the total resistance, it may also be appropriate to configure the sensor element, preferably the four sensor elements, in a wave-shaped form on the magnetic field sensor so that the magnetic field generated by the magnetic sensor element each time affects a large surface of the particular sensor element.

The measurement is advantageously conducted using the device according to the present invention in such a way that a change in the resistance of the sensor element, generated by an outer magnetic field, is determined. As soon as a defined threshold value is achieved, an analyzing circuit generates a switching signal. An incremental or digital process may be chosen here if the device is used as a rotational speed sensor or as a phase sensor. The device may, however, also be operated in an analog mode if it is used for position measuring or directly for field detection, for example for current measuring.

The sensor material is preferably positioned on a carrier material, for example made of a silicon wafer or a ceramic substrate, the sensor element forming one layer. The layer is deposited on the carrier material either as a thin layer according to a sputter method or another thin layer method, such as MBE (molecular beam epitaxy), CVD (chemical vapor deposition) or the like, or as a thick layer.

To achieve maximum sensitivity of the sensor material, i.e., to operate the magnetic field sensor in an area of the magneto resistance characteristic having maximum sensitivity and/or minimum temperature sensitivity, a magnetic auxiliary field may act on the sensor element. This auxiliary field may be generated by an auxiliary magnet mounted on the magnetic field sensor, the auxiliary magnet for example being made of a thin layer of a ferromagnetic material deposited on the sensor element.

To minimize the influence of interference fields on the magnetic field sensor, it may be designed as a gradiometer, so that it has two measuring points. Interference fields may thus be eliminated. To achieve higher signal amplitudes or sensitivities, the sensor material may be deposited on the carrier material in layer stacks.

The magnetic sensor element is, for example, a magnetic pole wheel, a ferromagnetic steel wheel system or, in the simplest embodiment, a simple magnet, which scans the magnetic field sensor once per rotation of the rotating component. The magnetic field generated by the magnetic sensor element is in a range between 1 μT and 50 mT, for example.

### BRIEF DESCRIPTION OF THE DRAWINGS

FIG. 1 shows a greatly simplified three-dimensional view of a wheel of a motor vehicle having a device according to the present invention.

FIG. 2 shows a greatly schematized illustration of a magnetic field sensor and a pole wheel of the device according to FIG. 1.

FIG. 3 shows an equivalent circuit diagram of the magnetic field sensor of the device according to FIGS. 1 and 2, which is designed as a Wheatstone bridge circuit.

FIG. 4 shows a view of a magnetic field sensor designed as a gradiometer.

### DETAILED DESCRIPTION

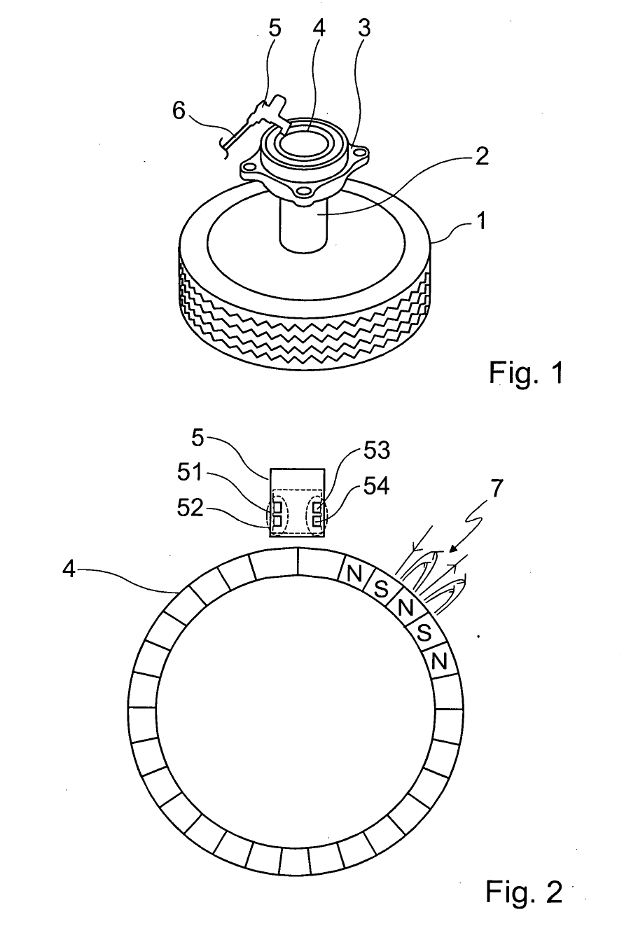

FIG. 1 shows wheel 1 of a vehicle, otherwise not shown in greater detail, connected to axis 2, which leads to a wheel bearing 3. Positioned in the area of wheel bearing 3 is a magnetic pole wheel 4, which is aligned concentrically with axis 2 and wheel 1, respectively, and coacts with magnetic field sensor 5, which is connected via a line 6 to a control unit not shown in greater detail.

As can be inferred from FIG. 2, pole wheel 4, which represents a magnetic sensor element, is made of alternately positioned magnetic north pole N and south pole S. Representative for the other areas of pole wheel 4, field lines are shown between each adjacent north and south pole for an area 7.

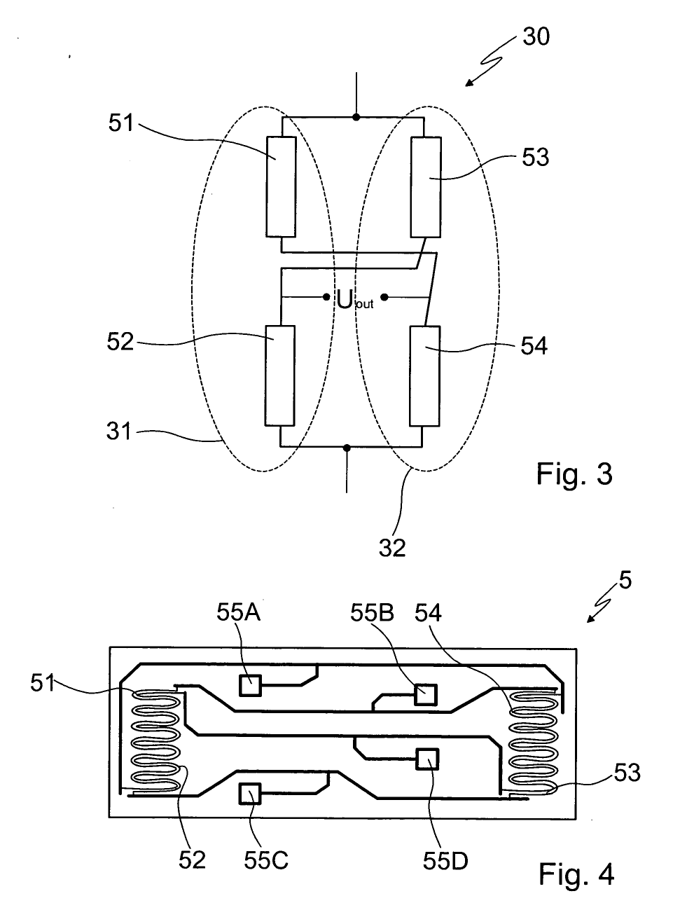

Magnetic field sensor 5, which coacts with pole wheel 4, is displaced in the radial direction of axis 2 opposite pole wheel 4 and may in practice be at a distance of about 10 mm from the latter, for example. Magnetic field sensor 5 includes four sensor elements 51, 52, 53 and 54, which act as electric resistors and are positioned opposite pole wheel 4 on a measuring head of magnetic field sensor 5. Sensor elements 51 and 52 form a first resistor pair, and sensor units 53 and 54 form a second resistor pair of Wheatstone bridge circuit 30, which is shown in greater detail in FIG. 3 and FIG. 4, respectively. Wheatstone bridge circuit 30 of magnetic field sensor 5 is designed as a gradiometer, individual resistors 51 through 54 each being positioned in a meander-shaped form on the measuring head of magnetic field sensor 5.

Sensor units 51 and 54 as well as sensor elements 52 and 53 are each assigned to a branch of bridge circuit 30, the two branches crossing, as can be seen in FIG. 3, in particular. The electric resistance of sensor elements 51 through 54 is measured via connector elements 55A, 55B, 55C and 55D, which are shown in FIG. 4.

Sensor elements 51 through 54 are made of an intermetallic compound of Heusler phases, i.e., CO₂Cr_{0.6}Fe_{0.4}Al, which is deposited on the measuring head of magnetic field sensor 5 as a polycrystalline powder or as temperature-treated, pressed pellets.

The rotational speed of wheel 1 may be inferred from a change in resistance in individual resistors 51 through 54 determined via Wheatstone bridge circuit 30. These values are applied to a vehicle stabilization program and a brake support program as well as to systems connected thereto.

Magneto resistance MR of the material CO₂Cr_{0.6}Fe_{0.4}Al used in this case at room temperature may be presented as a function of an external magnetic field μ₀H. The polycrystalline sample deposited in powder form shows a CMR effect considerably greater than that of the heat-treated, pressed pellets.

Furthermore, electric resistance R of Co₂Cr_{0.6}Fe_{0.4}Al may be presented as a function of temperature T, i.e., without an adjacent magnetic field and in an external magnetic field of 8T. It has been shown that electric resistance decreases when the magnetic field is applied, but the basic course of both resulting curves in the temperature range between 0 K and 300 K is largely compatible.

1. A device for detecting at least one of a rotational speed and a position of a rotating component, the device comprising:
at least one magnetic sensor element securely connected to the rotating component; and
a magnetic field sensor coacting with the sensor element, the magnetic field sensor being adapted to detect change in a magnetic field, the magnetic field sensor being connected to an analyzing circuit, the magnetic field sensor including at least one sensor element composed of a sensor material exhibiting a CMR (colossal magneto resistance) effect.

2. The device according to claim 1, wherein the sensor material includes an intermetallic compound of Heusler phases.

3. The device according to claim 1, wherein the sensor material includes at least one of CO₂Cr_{0.6}Fe_{0.4}Al, CO₂Cr_{0.2}Fe_{0.4}Ga, and CO₂Cr_{0.2}Mn_{0.8}Al.

4. The device according to claim 1, wherein the sensor material includes an electrically insulating compound.

5. The device according to claim 4, wherein the electrically insulating compound is Al₂O₃.

6. The device according to claim 1, wherein the at least one sensor element is a component of a Wheatstone bridge circuit.

7. The device according to claim 6, wherein the at least one sensor element includes four sensor elements which are composed of the sensor material and are assigned to the Wheatstone bridge circuit.

8. The device according to claim 1, wherein the at least one sensor element is configured on the magnetic field sensor in a meander-shaped form.

9. The device according to claim 1, wherein the at least one sensor element is situated on a carrier material and forms one of a layer and a layer stack.

10. The device according to claim 9, wherein the carrier material is composed of one of a silicon wafer and a ceramic substrate.

11. The device according to claim 1, wherein a magnetic auxiliary field acts on the at least one sensor element.

12. The device according to claim 11, wherein the magnetic auxiliary field is generated by an auxiliary magnet mounted on the magnetic field sensor.

13. The device according to claim 12, wherein the auxiliary magnet is composed of a thin layer deposited on the at least one sensor element.
